(19) United States
(12) Patent Application Publication
(10) Pub. No.: US 2018/0290590 A1
(43) Pub. Date: Oct. 11, 2018

(54) SYSTEMS FOR OUTPUTTING AN ALERT FROM A VEHICLE TO WARN NEARBY ENTITIES

(71) Applicant: GM Global Technology Operations LLC, Detroit, MI (US)

(72) Inventors: Claudia V. Goldman-Shenhar, Mevasseret Zion (IL); Yael Shmueli Friedland, Tel Aviv (IL); Douglas B. Moore, Howell, MI (US)

(21) Appl. No.: 15/481,654

(22) Filed: Apr. 7, 2017

(51) Int. Cl. B60Q 5/00; B60Q 9/00; B60Q 1/46

(52) U.S. Cl. CPC B60Q 5/008; B60Q 1/46; B60Q 5/006; B60Q 9/008

(57) ABSTRACT

The present disclosure relates to a system, for implementation at a vehicle to provide an alert from the vehicle to an entity (e.g., human, animal, another vehicle) external to the vehicle and within a proximity of the vehicle. The system includes a vehicle sensor, a vehicle output device, a hardware-based processing device, and a non-transitory computer-readable storage device having an alert manager agent/unit and an output unit. The alert manager agent includes code that, when executed, determines based on context data that the entity is within the predetermined proximity of the vehicle and selects an alert profile. The output unit includes code that, when executed, determines at least one output signal for implementing the alert profile. The output alert signal is sent to the vehicle output device that, provides the alert to be perceived by the entity.

### TECHNICAL FIELD

The present technology relates to outputting an alert from a vehicle to alert at least one nearby entity, such as a pedestrian or animal. More specifically, the technology relates to alerting the entity, which is within a predetermined proximity or area of a vehicle in operation, about the presence of the vehicle.

### BACKGROUND

Alternative fuel vehicles, such as electrical vehicles, are increasingly popular among drivers, as societies are becoming more resource conscious. Electrical vehicles provide an option for people to reduce or eliminate reliance on petroleum or other fuels to operate combustion-engine vehicles.

Auditory sounds provided by traditional fuel vehicles, such as sounds produced by the engine in operation, are not provided by electrical vehicle motors, especially at low speeds (e.g., less than 25 miles per hour). As such, pedestrians, bicyclists, and animals may not hear an approaching electrical vehicle, especially if distracted, such as by other traffic or a conversation. And, while a visually impaired persons may be better able to hear the vehicle and other environmental sounds, lacking visual clues to process along with the auditory indications, they may have a limited appreciation for the precise location or trajectory of the vehicle.

Some electric vehicles have been configured to produce acoustic alerts utilizing vehicle systems such as external microphones, vehicle speed systems, or Advance Driver Assistance systems (ADAS). However, these alerts also do not provide a context for altering the alert.

In some geographic areas, regulatory requirements have been put into place that require electric vehicles to produce a sound when traveling at low speeds. The sound produced may relate to the speed of the vehicle, adjusting in frequency or volume based on the speed of the vehicle. However, these regulatory requirements do not cover other circumstances in which it would be advantageous for electric vehicles to produce additional sound beyond regulatory requirements.

### SUMMARY

The need exists for vehicle systems that produce custom alerts, configured based on one or more contextual factors, such as regarding surroundings of the vehicle. Alerts customized to contextual circumstances provide better notification to nearby entities, such as pedestrians, bicyclists, animals, or other-vehicle drivers. Providing customized, or specific alerts will increase the likelihood of the entity reacting to the presence and/or movement of the vehicle.

The systems are controlled by an alert manager agent that determines, based on one or more sensor inputs, what alert, or alert variation, to provide under the specific conditions.

The present disclosure relates to a system, for implementation at a vehicle to provide an alert from the vehicle to an entity (e.g., human, animal, another vehicle) being external to and within a predetermined proximity of the vehicle. The system includes a vehicle sensor, a vehicle output device, a hardware-based processing device, and a non-transitory computer-readable storage device having an alert manager agent/unit and an output unit.

The alert manager agent includes code that is executed by the processing device. When executed, the code determines based on context data that the entity is within the predetermined proximity of the vehicle, yielding a first determination. In response to the first determination, the code determines an alert profile.

The output unit also includes code that is executed by the processing device. When executed, the code determines at least one output signal (or instruction) for implementing the alert profile determined. The code also sends the output alert signal to the vehicle output device that, provides the alert to be perceived by the entity external to the vehicle.

In some embodiments, the context data comprises at least one of vehicle context data, environmental context data, and user context data. In some embodiments, the non-transitory computer-readable storage device comprises at least one context unit selected from a group consisting of (i) a vehicle context unit comprising code that, when executed, determines vehicle context data based on vehicle input data, (ii) an environmental context unit comprising code that, when executed, generates environmental context data based on environmental input data, and (iii) a user context unit comprising code that, when executed, generates user context data based on user input data. In some embodiments, the vehicle context unit and the environmental context unit are determined by vehicle sensors or vehicle systems. In some embodiments, the user context unit is determined by vehicle microphone, vehicle camera, or a component of a connected mobile device.

In some embodiments, the code of the alert manager unit, in determining that the entity is within the predetermined proximity, determines that the entity is a person or animal and is within the predetermined proximity of the vehicle. In some embodiments, the code of the output agent code, determines the output signal for implementing the alert profile and sends the output alert signal to a vehicle output device for providing the alert to the person or animal external to the vehicle.

In some embodiments, the code of the alert manager unit, in determining that the entity is within the predetermined proximity, determines that the entity is a machine and is within the predetermined proximity of the vehicle. The alert profile indicates a visual and/or auditory alert. The code of the output agent, determines the output signal for implementing the alert profile determined to alert the machine and sends the output alert signal to a vehicle output device for providing the machine external to the vehicle.

In some embodiments, the code of the alert manager agent, in determining that the entity is within the predetermined proximity, further determines a requirement is met. In some embodiments, the requirement comprises at least one environmental context unit selected from a group consisting of inclement weather, visibility of light, or time of day. In some embodiments, the code of the alert manager agent, in determining that the entity is within the predetermined proximity, further determines a second requirement is met.

Other aspects of the present invention will be in part apparent and in part pointed out hereinafter.

### DESCRIPTION OF THE DRAWINGS

FIG. 1 illustrates schematically an alert management system in accordance with an exemplary embodiment.

FIG. 2 is a block diagram of a controller of the alert management system in FIG. 1.

FIG. 3 is a flow chart illustrating an exemplary sequence of the controller of FIG. 2.

The figures are not necessarily to scale and some features may be exaggerated or minimized, such as to show details of particular components. In some instances, well-known components, systems, materials or methods have not been described in detail in order to avoid obscuring the present disclosure.

Specific structural and functional details disclosed herein are not to be interpreted as limiting, but merely as a basis for the claims and as a representative basis for teaching one skilled in the art to variously employ the present disclosure.

### DETAILED DESCRIPTION

While the present technology is described primarily in connection with a vehicle in the form of an automobile, it is contemplated that the technology can be implemented in connection with other vehicles such as, but not limited to, marine craft, aircraft, machinery, and commercial vehicles (e.g., buses and trucks).

The embodiments described below are provided with reference primarily to electric vehicles. However, it is contemplated that the present technology can be implemented in connection with a hybrid vehicle or other alternative fuel vehicle. While a primary purpose is to provide alerts from vehicles that are quieter than gasoline-powered vehicles, it is contemplated that the technology can also be used with gasoline-powered vehicles.

The embodiments are described in association with human-operated vehicles. However, it is contemplated that the present technology can be utilized in autonomous or semi-autonomous driving vehicles, where a human may not operate some or all functions of the vehicle for a given amount of time.

Embodiments of vehicle alert systems are also described primarily herein with reference to the purpose of providing alerts, customized to the context of the situation, to notify entities such as humans (e.g., pedestrians), animals, and other vehicles. In contemplated scenarios, though, the alerts can be provided for detection by and/or detected by other entities, such as automobiles, personal mobile devices, or other machinery, like an autonomous vehicle or any vehicle configured to sense the customized alert provided.

Regarding personal mobile devices, for instance, a user's mobile phone or wearable may be configured to sense an alert, such as an audible and/or visual alert. A visually impaired person may use such wearable, for instance, and the same may be configured to in turn notify the person in a suitable manner, such as by other sound or haptic feedback.

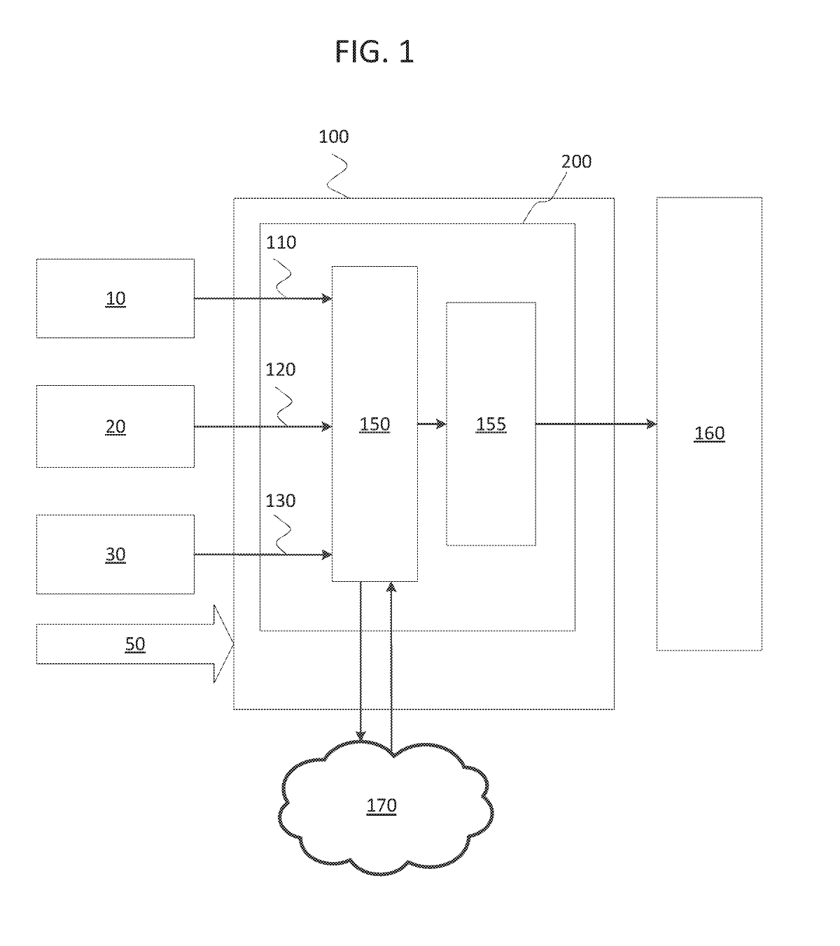

Now turning to the figures, and more particularly to the first figure, FIG. 1 shows an alert management system 100. The system 100 identifies and interprets (e.g., processes) inputs received into an alert manager unit or agent 150, and produces an auditory or visual alert using one or more output devices 160. The system 100 receives one or more contextual inputs (e.g., data), such as (i) vehicle context unit 110 derived (e.g., by the agent 150) from vehicle inputs 10, (ii) environmental context unit 120 derived (e.g., by the agent 150) from environmental inputs 20, and (iii) user/occupant context unit 130 derived (e.g., by the agent 150) from user/occupant inputs 30, collectively contexts.

The context units 110, 120, 130 are code units provided to the agent 150. Specifically, the context units 110, 120, 130 are stored and executed by the controller 200 (e.g., stored in a memory 210 and executed by a processor 260), described below.

In various embodiments, the system 100 uses inputs based on spatial directivity (e.g., determining an entity that is nearby the vehicle) to choose an alert that is communicated (e.g., using the output device 160) external to the electric vehicle while in operation. Because electric vehicles do not make sounds associated with typical fuel vehicles (e.g., operation of an engine), the system 100 manages alerts used to visually and/or audibly warn humans and animals near the electric vehicle while it is in operation, to warn of or prevent a potential accident.

References herein to system components performing functions includes, as mentioned, the system processor executing corresponding computer-executable instruction to perform the function. For brevity, the performing processor is not always mentioned. Description of the alert manager agent 150 performing a function includes the processor performing the function using corresponding system code for the alert manager agent 150.

The agent 150 receives the context units 110, 120, 130, which are contextual derivations produced by the system 100 when executed (e.g., by a processor), respective context inputs 10, 20, 30. Specifically, the agent 150 (i.e., the processor executing code of the alert manager agent 150) receives information (e.g., data) and determines the alert profile that is best suited for conditions perceived. The agent 150 chooses a suitable alert profile to output to the device(s) 160 to better warn nearby vehicles, pedestrians, or animals, using contextual and spatial determinations.

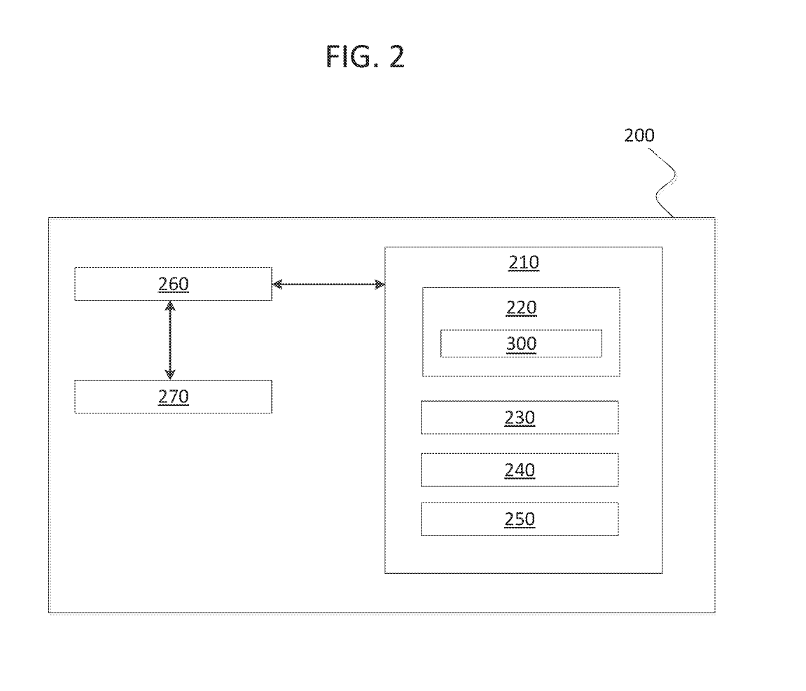

The alert manager agent 150 includes code stored within and executed by components (e.g., memory and processor) of one or more controllers 200. Specifically, the controller 200 receives the data input from the context units 110, 120, 130, analyzes the input, and provides output data (e.g., using output agent 15) in the format of an alert profile to the output device 160. Further description of the controller 200 is described below in association with FIG. 2.

In some embodiments, the system 100 provides contextual determination using various alert profiles that alter characteristics of a specific alert profile duration, intensity, tempo, pitch, volume, harmony, and cadence, among others, to provide a contextually-suitable warning to humans and animals. For each contextual condition, as determined by the context units 110, 120, 130, described below, the system 100 provides a different alert profile to the output device(s) 160.

In some embodiments, the system 100 provides an alert profile, or alters a pre-existing alert profile, to indicate urgency, risk, or potential harm to the human, animal, or vehicle nearby. The system 100 determines a level of urgency of a current situation based on vehicle context unit 110, environmental context unit 120, and user/operator context unit 130.

In some embodiments, an alert profile is altered based on the urgency as perceived by the system 100. The same alert profile is used for the same condition; however the alert profile can have varied characteristics (e.g., tempo, cadence) depending on the urgency of the situation (e.g., as a pedestrian approaches closer to the vehicle). Below is an example of a predefined alert profile that varies according to urgency as perceived by the conditions provided by the contexts units 110, 120, 130.

| | Low | Medium | High |
|---|---|---|---|
| Context | Urgency | Urgency | Urgency |
| Condition #1 | Alert 1 | Alert 1 | Alert 1 |
| (e.g., single person) | (tempo 1) | (tempo 2) | (tempo 3) |
| Condition #2 | Alert 2 | Alert 2 | Alert 2 |
| (e.g., group of people) | (tempo 1) | (tempo 2) | (tempo 3) |

For example, when a sound alert is used, the system 100 provides the output device 160 with a sound profile that has a first cadence or tempo when the human or animal being notified is not in close proximity to the vehicle, and a second, increased cadence/tempo when the person or animal is close to the vehicle or, by their and/or vehicle movement is, becoming closer to the vehicle. The system 100 may be programmed with various thresholds for evaluating proximity of people, animals, or other apparatus, such as an autonomous vehicle. As an example, the system 100 may provide a first alert if a pedestrian is between 50 and 25 meters from the vehicle, a second alert if between 25 and 10 meters, and a third if less than 10 meters. Besides distance, the system 100 considers variable in various embodiments movement of the host vehicle, the pedestrian or other, such as relative trajectory. As mentioned, various alerts can differ by, for example, the alert medium—audible, visual, and/or other—and/or characteristic(s)—e.g., volume, brightness, tempo, and/or other.

In some embodiments, various alert profiles are selected based on the urgency as perceived by the system 100. Different alert profiles are used for each condition and urgency of the situation. Below is an example of various alert profiles that depend on the urgency as perceived by the conditions provided by the context units 110, 120, 130.

| | Low | Medium | High |
|---|---|---|---|
| Context | Urgency | Urgency | Urgency |
| Condition #1 | Alert 1 | Alert 2 | Alert 3 |
| (e.g., single person) | | | |
| Condition #2 | Alert 4 | Alert 5 | Alert 6 |
| (e.g., group of people) | | | |

As an example, where the human/animal is not in close proximity to the vehicle, the system 100 provides the output device 160 with a first sound profile, and as the human/animal continues to approach, the agent 150 would communicate a second profile to the output device 160 that is different than the first sound profile.

The alert profiles are determined (e.g., modulated) as a function of one or more contexts such as vehicle context unit 110, environmental context unit 120, and user/occupant context unit 130. In some embodiments, this context data is received continuously into the agent 150. In other embodiments, this context data is received by the agent 150 at predetermined time intervals or upon specific conditions being met (e.g., a moving object is perceived using vehicle sensors).

The vehicle context unit 110 is interpreted by the controller 200 by analyzing information (e.g., data) received from vehicle systems and sub-systems.

Specifically, the vehicle context unit 110 is determined from vehicle inputs 10, which include information from specific vehicle systems and sub-systems that may be pertinent to making a determination of whether an alert is needed for a perceived condition. Vehicle inputs 10 include, for example, vehicle speed, vehicle acceleration, geographic positioning system (GPS), proximity-sensing systems, and braking systems, among others.

Vehicle context unit 110 can also include vehicle mechanisms that produce or control properties of sound or light (e.g., intensity or localization). Vehicle inputs 10 into the localization mechanisms include scene cameras and vehicle sensors, for example.

Vehicle context unit 110 also includes vehicle systems such as advanced driver assistance systems (ADAS). Vehicle inputs 10 into the ADS system may include radar and sensors, for example.

Vehicle context unit 110 is provided to the system 100 to determine if an alert is needed. For example, where vehicle sensors perceive the vehicle is at a known tourist location, based on the GPS system, the system 100 would provide an alert profile to the output device 160 that is suitable for warning pedestrians that may be tourists. Specifically, the system 100 takes into account, using vehicle context unit 110, that the known tourist location (e.g., as determined by GPS location) may have higher noise levels and the pedestrians (tourists) may be distracted. As such, the system 100 would produce an alert profile that is suitable for warning potentially distracted pedestrians rather than producing an alert profile that would only be suitable for warning an undistracted pedestrian.

Environmental context unit 120 is interpreted by the controller 200 by analyzing information received from an area immediately surrounding the vehicle up to and including a predetermined distance from the vehicle.

Environmental context unit 120 is determined from environmental inputs 20, which include information about conditions external to the vehicle—i.e., external context. This external context is perceived from equipment integrated or subsequently attached to the vehicle, such scene sensors and cameras. The equipment may perceive environmental context such as weather, visibility (e.g., based on hour of day), hazards or other road conditions, nearby vehicles (e.g., being passed, being behind), and areas of high pedestrian density (e.g. tourist location), among others.

Environmental context unit 120 also includes environmental inputs 20 that provide information concerning conditions internal to the vehicle, such as vehicle systems (e.g., acoustics within the vehicle, weather-related systems, traffic-monitoring systems, and vehicle to infrastructure (v2I)) or mobile device applications utilized by persons inside or outside of the vehicle.

Environmental context unit 120 also includes environmental inputs 20 that can provide information irrespective of whether a condition occur internal or external to the vehicle. For example, environmental inputs 20 includes noise background, which receives inputs from vehicle devices (e.g., scene cameras, sensors), mobile device applications from users, and vehicle systems (e.g., acoustics within the vehicle, weather systems, traffic systems, v2I).

Environmental context unit 120 is provided to the system 100 to determine if an alert is needed. For example, where vehicle sensors perceive a large number of pedestrians, the system 100 would provide an alert profile to the output device 160 that is suitable for warning the large number of pedestrians. Specifically, the system 100 takes into account, using environmental context unit 120, that the large number of pedestrians may be distracted by one another. As such, the system 100 would produce an alert profile that is suitable for warning the large number of potentially distracted pedestrians rather than producing an alert profile that would only be suitable for warning a single pedestrian.

User context unit 130 is interpreted by the controller 200 by analyzing information received from a vehicle operator or a vehicle occupant—i.e., user input 30. User context unit 130 can quantify conditions that may or may not be perceived by vehicle systems when identifying vehicle context unit 110 and environmental context 120. For example, a vehicle operator may perceive pedestrians that are at high risk for accident (e.g., pedestrians with disabilities in a hospital area, elderly pedestrians near a nursing home, and children near a school crossing) and socio-geographic locations (e.g., children at a playground, persons participating at a sporting event).

User context unit 130 is provided to the system 100 to determine if an alert is needed. The user context unit 130 can be interpreted in light of vehicle context unit 110 and environmental context unit 120 to provide an adequate alert profile.

For example, where user context unit 130 includes recognition that a braking function has occurred by the vehicle operator (user input 30), the system 100 also uses GPS information (vehicle input 10) to identify the vehicle is in proximity to a hospital. Additionally, the system 100 uses external vehicle sensors to perceive pedestrians (environmental input 20) who are in proximity to the vehicle. Utilizing the inputs 10, 20, 30, the context units 110, 120, 130 are provided to the agent 150 and analyzed by the controller 200. Ultimately the system 100 provides a sound profile to the output device 160 that is suitable to warn possibly disabled pedestrians in a hospital area.

In some embodiments, the vehicle user or occupant provides input 50 directly into the agent 150 that is directly used to determine an alert profile to provide to the output devices(s) 160.

Data from the context units 110, 120, 130, once received by the controller 200 can be optionally stored to a repository 170. The repository 170 can be internal to the system 100 and/or vehicle, or external to the system 100 and/or vehicle, such as by being part of a remote database, remote to the vehicle and system 100.

The data stored to the repository 170 can be used to provide additional context to the controller 200 to determine an alert profile contextually suitable for the conditions perceived. Stored data can include locations of points of interests (e.g., hospitals, tourists locations), times of day where specific events occur (e.g., school zones), and times of day where visibility may be difficult (e.g., heavy rain or fog). The repository 170 can also store conditions for which a specific alert profile was used. For example, where multiple predetermined conditions are met, a specific alert profile is communicated to the controller 200.

The data is stored within the repository 170 as computer-readable code by any known computer-usable medium including semiconductor, magnetic disk, optical disk (such as CD-ROM, DVD-ROM) and can be transmitted by any computer data signal embodied in a computer usable (e.g., readable) transmission medium (such as a carrier wave or any other medium including digital, optical, or analog-based medium).

In some embodiments, the repository 170 aggregates data across multiple users. Aggregated data can be derived from a community of users whose behaviors are being monitored by the system 100 and may be stored within the repository 170. Having a community of users allows the repository 170 to be constantly updated with the aggregated queries, which can be communicated to the controller 200. The queries stored to the repository 170 can be used to provide alerts for contextually suited for the specific conditions present.

FIG. 2 illustrates the controller 200, which is an adjustable hardware. The controller 200 may be a microcontroller, microprocessor, programmable logic controller (PLC), complex programmable logic device (CPLD), field-programmable gate array (FPGA), or the like. The controller 200 may be developed through the use of code libraries, static analysis tools, software, hardware, firmware, or the like. Any use of hardware or firmware includes a degree of flexibility and high-performance available from an FPGA, combining the benefits of single-purpose and general-purpose systems.

The controller 200 includes a memory 210. The memory 210 may include several categories of software and data used in the controller 200, including, applications 220, a database 230, an operating system (OS) 240, and input/output (I/O) device drivers 250.

As will be appreciated by those skilled in the art, the OS 240 may be any operating system for use with a data processing system. The I/O device drivers 250 may include various routines accessed through the OS 240 by the applications 220 to communicate with devices and certain memory components.

The applications 220 can be stored in the memory 210 and/or in a firmware (not shown) as executable instructions and can be executed by a processor 260.

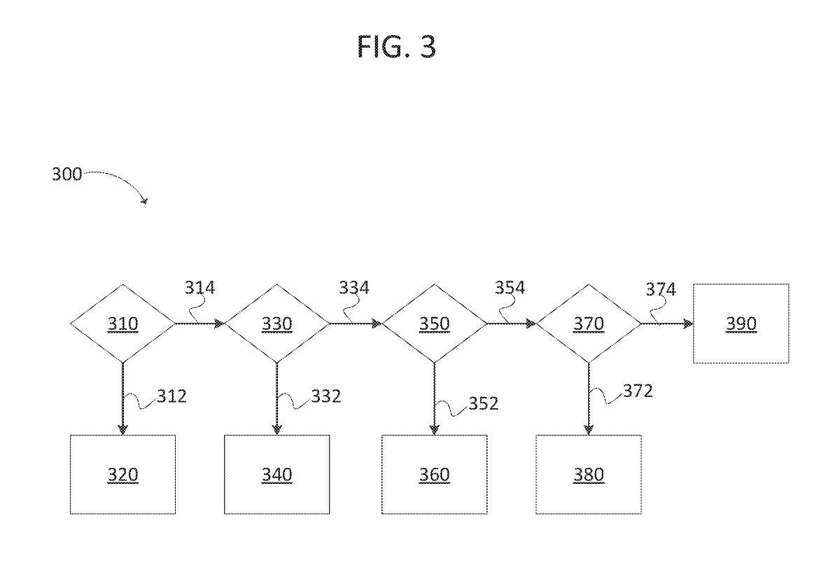

The applications 220 include various programs, such as a sequence 300 (shown in FIG. 3) described below that, when executed by the processor 260, process data received into the alert manager agent 150.

The applications 220 may be applied to data stored in the database 230, such as the specified parameters, along with data, e.g., received via the I/O data ports 270. The database 230 represents the static and dynamic data used by the applications 220, the OS 240, the I/O device drivers 250 and other software programs that may reside in the memory 210.

While the memory 210 is illustrated as residing proximate to the processor 260, it should be understood that at least a portion of the memory 210 can be a remotely accessed storage system, for example, a server on a communication network, a remote hard disk drive, a removable storage medium, combinations thereof, and the like. Thus, any of the data, applications, and/or software described above can be stored within the memory 210 and/or accessed via network connections to other data processing systems (not shown) that may include a local area network (LAN), a metropolitan area network (MAN), or a wide area network (WAN), for example.

It should be understood that FIG. 2 and the description above are intended to provide a brief, general description of a suitable environment in which the various aspects of some embodiments of the present disclosure can be implemented. While the description refers to computer-readable instructions, embodiments of the present disclosure can also be implemented in combination with other program modules and/or as a combination of hardware and software in addition to, or instead of, computer readable instructions.

The term “application,” or variants thereof, is used expansively herein to include routines, program modules, programs, components, data structures, algorithms, and the like. Applications can be implemented on various system configurations including single-processor or multiprocessor systems, minicomputers, mainframe computers, personal computers, hand-held computing devices, microprocessor-based, programmable consumer electronics, combinations thereof, and the like.

Referring back to FIG. 1, once selected by the system 100, the alert profile is output to the output device 160 by way of an output unit or agent 155. The output agent 155 includes code that, when executed by the processor 260, provides an output signal (or instruction) for implementing the alert profile. The output agent 155 sends the output alert signal to the vehicle output device 160. In some embodiments, the output agent 155 is a part of the agent 150. In other embodiments, the output agent is separate from the agent 150, as illustrated in FIG. 1.

The system 100 additionally includes one or more output devices 160. The output device(s) 160, in operation of the system 100, provides an alert (e.g., sound, light, visual display) that can be perceived by the entity (e.g., human or animal) that is external to the vehicle.

The output device(s) 160 can be any device that would provide communication to the nearby pedestrian or hazard. For example, the output devices(s) 160 are speakers mounded into/onto the vehicle, lights, or display screens mounted into/onto the vehicle.

The output device 160 can provide a sound alert that is audibly perceived by humans or animals in the vicinity of the vehicle. The sound alert can be produced from one or more speakers integrated into or affixed onto the vehicle. The sound alert includes auditory output including, for example tones or verbal notifications. The sound alerts can include adjustable characteristics such as tone of the alert, volume at which the alert is played from the speakers, and tempo at which the alert is played, among others.

The output device 160 can provide a visual alert that is visually perceived by humans or animals in the vicinity of the vehicle. The visual alert can be produced from one or more lights or displays integrated into or affixed onto the vehicle. The visual alert includes a visible output that can be adjusted (e.g., frequency and intensity) to meet contextually-suited conditions. The visual alert also may include visible displays that can be adjusted (e.g., font size and background lighting) to meet contextually-suited conditions.

The system 100 can include one or more other devices and components within the system 100 or in support of the system 100. For example, multiple controllers may be used to recognize context. In some embodiments, some an alert might require additional hardware such as amplifiers, among others.

FIG. 3 is a flow chart illustrating methods for performing a contextual alert sequence 300.

It should be understood that the steps of the methods are not necessarily presented in any particular order and that performance of some or all the steps in an alternative order, including across these figures, is possible and is contemplated.

The steps have been presented in the demonstrated order for ease of description and illustration. Steps can be added, omitted and/or performed simultaneously without departing from the scope of the appended claims. It should also be understood that the illustrated method or sub-methods can be ended at any time.

In certain embodiments, some or all steps of this process, and/or substantially equivalent steps are performed by a processor (e.g., processor 260), e.g., computer processor, executing computer-executable instructions, corresponding to one or more corresponding algorithms, and associated supporting data stored or included on a computer-readable medium, such as any of the computer-readable memories described above, including the remote server and vehicles.

The sequence 300 begins by receiving the context units 110, 120, 130 by the system 100 at step 310. This software may be initiated through the controller 200. The context units 110, 120, 130 may be received into the system 100 according to any of various timing protocols, such as continuously or almost continuously, or at specific time intervals (e.g., every ten seconds), for example. The context units 110, 120, 130 may, alternately, be received based on a predetermined occurrence of events (e.g., activation of a specific vehicle system or existence of a predetermined condition, such as a threshold level of brightness being sensed).

Once initiated, the sequence 300 determines if a hazard (e.g., pedestrian or animal) is present at step 310. As described above, a pedestrian or animal can be identified by the system 100 through the interpretation of the context units 110, 120, 130 based on the inputs 10, 20, 30.

If a pedestrian is not present (e.g., path 312), then no alert is produced at step 320.

If a pedestrian or hazard present is (e.g., path 314), then the sequence 300 moves to step 330.

At step 330, the sequence 300 determines if a first condition is met. The first condition can be any number of conditions that could be interpreted using the agent 150 to alert the pedestrian or hazard. For example, the sequence 300 determines if an unfavorable or inclement weather condition (e.g., heavy rain or fog) is present.

If the first condition is not met (e.g., path 332), then a first alert profile is produced at step 340. The first alert profile is provided to the output device 160 by way of the output agent 155.

The first alert profile can include an audible sound or sound sequence plays through a speaker (output device 160) mounted to the exterior of the vehicle. Additionally or alternately, a light or light sequence may be emitted from a light (output device) mounted onto the exterior of the vehicle in a location that the emitted light would be perceived by a pedestrian or animal. For example, where there is heavy fog, a sound may be emitted using a speaker because a light may not be seen by the pedestrian, due to light reflection by the fog. However, where there is rain, a light may be emitted to alert the pedestrian. The system 100 may determine, based on the context units 110, 120, 130, the difference between rain and fog by vehicle inputs such as sensors that monitor temperature or cameras that display conditions.

If the first condition is met (e.g., path 334), the sequence 300 moves to step 350.

At step 350, the sequence 300 determines if a second condition is met. Similar to the first condition, the second condition can be any number of conditions that could be interpreted using the agent 150 to provide an alert profile that will alert the pedestrian or animal using the output device 160. For example, the second condition determines if another vehicle is nearby. Additionally, the second condition could determine if the nearby vehicle is passing the user vehicle.

If the second condition is not met (e.g., path 352), then a second alert profile is produced at step 360. Similar to the first alert profile, the second alert profile is provided to the output device 160 by way of the output agent 155.

The second alert profile is different that the first alert profile to provide a different context of the situation, as perceived by the system 100, to the pedestrian or animal. For example, where there is rain (first condition) and another vehicle is passing the user vehicle (second condition), the system 100 provides an audible sound profile, as the pedestrian may not see a visible light, if produced, due to the passing vehicle. The second alert profile is meant to provide the best alert for the combination of the conditions met, namely the first and second conditions.

If the second condition is met (e.g., path 354), the sequence 300 moves to step 370.

At step 370, the sequence 300 determines if a third condition is met. Similar to the first and second conditions, the third condition is interpreted using the agent 150 to provide an alert profile that will alert the pedestrian or animal using the output device 160. For example, the third condition determines the time of day. The system 100 can determine the time of day by using vehicle inputs 10 such as environmental sensors that monitor the amount of light that passes through a vehicle-mounted sensor. Alternatively, the system 100 can determine night by using vehicle inputs 10 such as the vehicle time clock.

If the third condition is not met (e.g., path 372), then a third alert profile is produced at step 380. The third alert profile is different that the first and second alert profiles. For example, where there is rain (first condition), another vehicle is passing the user vehicle (second condition), and it is night (third condition), the system 100, using the output agent 155, will provide an alert profile that includes audible sound and a visible light to provide additional warning for the pedestrian or animal.

If the third condition is met (e.g., path 374), than a fourth alert profile is provided at step 390. The fourth alert profile, similar to the second and third alert profiles, are meant to provide the best alert profile for the combination of the conditions met.

It will also be recognized that the first, second, third, and fourth alerts as described above can each be variations of the same alert. For example, the second, third, and fourth alert can be a variation of the first alert.

Furthermore, it will be recognized that the conditions at steps 330, 350, 370 can be the same condition where the urgency of the condition is increased (e.g., a pedestrian approaches the vehicle). For example, the first condition at step 330 identifies a condition of low urgency, which ultimately would produce the first alert profile at step 340. Similarly, the second condition at step 350 identifies a condition of medium urgency and the third condition at step 370 identifies a condition of high urgency, which respectively produce the second alert profile at step 360 and the third alert profile at step 380.

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components herein in connection with one or more functions is to be interpreted to cover embodiments in which a single component performs the function(s).

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

The above-described embodiments are merely exemplary illustrations of implementations set forth for a clear understanding of the principles of the disclosure. The disclosed embodiments may be embodied in various and alternative forms, and combinations thereof without departing from the scope of the claims. All such variations, modifications, and combinations are included herein by the scope of this disclosure and the following claims.

What is claimed is:

1. A system, for implementation at a vehicle of transportation to provide an alert from the vehicle to an entity being external to and within a predetermined proximity of the vehicle, comprising:
a vehicle sensor;
a vehicle output device;
a hardware-based processing device; and
a non-transitory computer-readable storage device comprising an alert manager unit and an output unit, wherein:
the alert manager unit comprises code that, when executed by the processing device, determines, based on context data, that the entity is within the predetermined proximity of the vehicle, yielding a first determination, and determines, in response to the first determination, an alert profile; and
the output unit comprises code that, when executed by the processing device, determines at least one output signal or instruction for implementing the alert profile determined, and sends the output alert signal or instruction to the vehicle output device that, in operation of the system, provides the alert to be perceived by the entity external to the vehicle.

2. The system of claim 1 wherein:
the context data comprises at least one of vehicle context data, environmental context data, and user context data; and
the non-transitory computer-readable storage device comprises at least one context unit selected from a group consisting of:
a vehicle context unit comprising code that, when executed by the processing device, determines vehicle context data based on vehicle input data;
an environmental context unit comprising code that, when executed by the processing device, generates environmental context data based on environmental input data; and
a user context unit comprising code that, when executed by the processing device, generates user context data based on user input data.

3. The system of claim 2 wherein the vehicle context unit and the environmental context unit are determined by vehicle sensors or vehicle systems.

4. The system of claim 2 wherein the user context unit is determined by vehicle microphone, vehicle camera, or a component of a connected mobile device.

5. The system of claim 1 wherein:
the code of the alert manager unit, in determining that the entity is within the predetermined proximity, when executed by the processing device, determines that the entity, being a person or animal, is within the predetermined proximity of the vehicle; and
the code of the output agent code, when executed by the processing device, determines the output signal or instruction for implementing the alert profile determined to alert the person or animal, and sends the output alert signal or instruction to a vehicle output device for providing the alert to the person or animal external to the vehicle.

6. The system of claim 1 wherein:
the code of the alert manager unit, in determining that the entity is within the predetermined proximity, when executed by the processing device, determines that the entity, being a machine, is within the predetermined proximity of the vehicle;
the alert profile indicates a visual or auditory alert; and
the code of the output agent, when executed by the processing device, determines the output signal or instruction for implementing the alert profile determined to alert the machine, and sends the output alert signal or instruction to a vehicle output device for providing the machine external to the vehicle.

7. The system of claim 2 wherein the code of the alert manager unit, in determining that the entity is within the predetermined proximity, further determines a requirement is met.

8. The system of claim 7 wherein the requirement comprises at least one environmental context unit selected from a group consisting of inclement weather, visibility of light, or time of day.

9. The system of claim 8 wherein:
the requirement is a first requirement; and
the code of the alert manager unit, in determining that the entity is within the predetermined proximity, further determines a second requirement is met.

10. A system, for implementation at a vehicle of transportation to provide an alert from the vehicle to an entity being external to and within a predetermined proximity of the vehicle, comprising:
a vehicle output device;
a hardware-based processing device; and
a non-transitory computer-readable storage device comprising an alert manager unit and an output unit, wherein:
the alert manager unit comprises code that, when executed by the processing device, determines, based on context data, that the entity is within the predetermined proximity of the vehicle, yielding a first determination, and determines, in response to the first determination, an alert profile; and
the output unit comprises code that, when executed by the processing device, determines at least one output signal or instruction for implementing the alert profile determined, and sends the output alert signal or instruction to the vehicle output device that, in operation of the system, provides the alert to be perceived by the entity external to the vehicle.

11. The system of claim 10 wherein:
the context data comprises at least one of vehicle context data, environmental context data, and user context data; and
the non-transitory computer-readable storage device comprises at least one context unit selected from a group consisting of:
a vehicle context unit comprising code that, when executed by the processing device, determines vehicle context data based on vehicle input data;
an environmental context unit comprising code that, when executed by the processing device, generates environmental context data based on environmental input data; and
a user context unit comprising code that, when executed by the processing device, generates user context data based on user input data.

12. The system of claim 11 wherein the user context unit is determined by vehicle microphone, vehicle camera, or a component of a connected mobile device.

13. The system of claim 10 wherein:
the code of the alert manager unit, in determining that the entity is within the predetermined proximity, when executed by the processing device, determines that the entity, being a person or animal, is within the predetermined proximity of the vehicle; and
the code of the output agent code, when executed by the processing device, determines the output signal or instruction for implementing the alert profile determined to alert the person or animal, and sends the output alert signal or instruction to a vehicle output device for providing the alert to the person or animal external to the vehicle.

14. The system of claim 10 wherein:
the code of the alert manager unit, in determining that the entity is within the predetermined proximity, when executed by the processing device, determines that the entity, being a machine, is within the predetermined proximity of the vehicle;
the alert profile indicates a visual or auditory alert; and
the code of the output agent, when executed by the processing device, determines the output signal or instruction for implementing the alert profile determined to alert the machine, and sends the output alert signal or instruction to a vehicle output device for providing the machine external to the vehicle.

15. A system, for implementation at a vehicle of transportation to provide an alert from the vehicle to an entity being external to and within a predetermined proximity of the vehicle, comprising:
a vehicle sensor;
a hardware-based processing device; and
a non-transitory computer-readable storage device comprising an alert manager unit and an output unit, wherein:
the alert manager unit comprises code that, when executed by the processing device, determines, based on context data, that the entity is within the predetermined proximity of the vehicle, yielding a first determination, and determines, in response to the first determination, an alert profile; and
the output unit comprises code that, when executed by the processing device, determines at least one output signal or instruction for implementing the alert profile determined, and sends the output alert signal or instruction to the vehicle output device that, in operation of the system, provides the alert to be perceived by the entity external to the vehicle.

16. The system of claim 15 wherein:
the context data comprises at least one of vehicle context data, environmental context data, and user context data; and
the non-transitory computer-readable storage device comprises at least one context unit selected from a group consisting of:
a vehicle context unit comprising code that, when executed by the processing device, determines vehicle context data based on vehicle input data;
an environmental context unit comprising code that, when executed by the processing device, generates environmental context data based on environmental input data; and
a user context unit comprising code that, when executed by the processing device, generates user context data based on user input data.

17. The system of claim 16 wherein the vehicle context unit and the environmental context unit are determined by vehicle sensors or vehicle systems.

18. The system of claim 16 wherein the user context unit is determined by vehicle microphone, vehicle camera, or a component of a connected mobile device.

19. The system of claim 15 wherein:
the code of the alert manager unit, in determining that the entity is within the predetermined proximity, when executed by the processing device, determines that the entity, being a person or animal, is within the predetermined proximity of the vehicle; and
the code of the output agent code, when executed by the processing device, determines the output signal or instruction for implementing the alert profile determined to alert the person or animal, and sends the output alert signal or instruction to a vehicle output device for providing the alert to the person or animal external to the vehicle.

20. The system of claim 15 wherein:
the code of the alert manager unit, in determining that the entity is within the predetermined proximity, when executed by the processing device, determines that the entity, being a machine, is within the predetermined proximity of the vehicle;
the alert profile indicates a visual or auditory alert; and
the code of the output agent, when executed by the processing device, determines the output signal or instruction for implementing the alert profile determined to alert the machine, and sends the output alert signal or instruction to a vehicle output device for providing the machine external to the vehicle.
